(19) United States
(12) Patent Application Publication
(10) Pub. No.: US 2008/0297350 A1
(43) Pub. Date: Dec. 4, 2008

(54) Rfid Tag

(75) Inventors: Shigeyuki Iwasa, Tokyo (JP); Yukiko Morioka, Tokyo (JP); Masahiro Suguro, Tokyo (JP); Yuki Kusachi, Tokyo (JP); Jiro Iriyama, Tokyo (JP); Kentaro Nakahara, Tokyo (JP); Sadahiko Miura, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Minato-ku, Tokyo (JP)

(21) Appl. No.: 12/093,559

(22) PCT Filed: Dec. 4, 2006
(86) PCT No.: PCT/JP2006/324185

§ 371 Date: Jul. 9, 2008

(30) Foreign Application Priority Data
Dec. 5, 2005 (JP) 2005-350877
Oct. 30, 2006 (JP) 2006-294271

(51) Int. Cl. G08B 13/22

(52) U.S. Cl. 340/572.1

(57) ABSTRACT

To provide an RFID tag including therein a lightweight, thin, reusable by charging, and foldable power source. In an RFID tag including an IC module 2, an antenna 3, and a power source and with a thickness of 0.9 mm or less, there is included an organic radical battery with a thickness of 0.7 mm or less as the power source.

### TECHNICAL FIELD

The present invention relates to a RFID tag including an Integrated Circuit (IC) module, an antenna, and a power source, and in particular, to an RFID tag including a chargeable and dischargeable secondary battery as a power source.

### RELATED ART

As for the RFID tag (a generic name of a wireless device employed for Radio Frequency Identification (RFID)), an IC card which is held by a person and which conducts communication using an electromagnetic wave with a reader-writer (reading/writing) device and the like is called a contactless IC card. The contactless IC card basically includes a plastic card and an IC module and an antenna which are disposed in the plastic card. Between the contactless IC card and the reader-writer device for the IC card, supply of power, a clock signal, and the like as well as input and output of information such as data and commands are carried out by using an electromagnetic wave.

Also, some contactless IC cards include a power source in addition to the IC module and the antenna (refer to, for example, Patent Document 1). Such IC card is constructed using two plastic sheets between which the power source is sealed together with the IC module and the antenna. The contactless IC card including a power source has, when compared with the card not including a power source, an advantage of capability of long-distance information transmission (several tens of meters). As the power source disposed in such IC card, there can be considered a thin-film lithium coin battery which is a primary battery and a rechargeable lithium-ion battery, a rechargeable nickel-hydrogen battery, and a lead battery which are rechargeable batteries (secondary batteries).

However, an IC card with a primary battery therein has a problem in which when the end of the battery life comes, the IC card does not conduct its function. In comparison therewith, when a rechargeable battery described above is installed in the IC card, the IC card is also repeatedly used by charging the rechargeable battery. As such attempt, there exists an item described in, for example, Patent Document 2. However, when the rechargeable battery described above is employed, the charging thereof takes a long period of time, for example, at least one hour. Also, when two years or more lapse, the rechargeable battery is greatly lowered in its capacity; the charging is frequently required unless the battery is replaced.

Additionally, the contactless IC card has a size generally conforming to the international standard size called an ID-1 card and has the same size and thickness as a cash card and a credit card (length 54.0 mm×width 85.7 mm×thickness 0.76 mm). However, the card thickness is mainly 0.76 mm conforming to the international standard and actually varies; some cards have a thickness of about 0.9 mm. Therefore, as a power source to be disposed in such IC card of the international standard size, the thickness thereof must be reduced and equal to or less than about 0.7 mm in consideration of the card thickness. However, the thin-film lithium coin battery, the rechargeable lithium-ion battery, and the rechargeable nickel-hydrogen battery described above require a thickness equal to or more than one millimeter, and hence it is not possible to produce an IC card of the international standard size. In the present state of the art, although there exists a thin-film capacitor as a power source device which can be installed in a card with a thickness of 0.76 mm, this has a problem of a small storage capacity.

Moreover, it is also assumed that the contactless IC card is placed in a hip pocket of a pair of pants and is bent when the holder thereof stoops. In addition, it is assumed that in addition to a situation in which the contactless IC card is held by the holder thereof, the card is used to be fixed onto an object with a curved surface. However, the thin-film capacitor, the lithium coin battery, and the conventional rechargeable lithium-ion battery are too stiff to be bent. Hence, there exists a problem that the power sources described above cannot be adopted for the RFID tag and the contactless IC card which is put in the situation wherein the tag and the card are bent.
Patent Document 1: Japanese Patent Laid-Open Publication Ser. No. Hei-7-262333
Patent Document 2: International Publication Ser. No. WO01/97300
Patent Document 3: Japanese Patent Laid-Open Publication Ser. No. 2002-151084
Patent Document 4: Japanese Patent Laid-Open Publication Ser. No. 2002-304996
Patent Document 5: Japanese Patent Laid-Open Publication Ser. No. 2003-308839

### DISCLOSURE OF THE INVENTION

### Problem to be Solved by the Invention

In the situation described above, it is desired that the power source to be arranged in an RFID tag of a contactless IC card or the like which is also assumed to be bent can be installed in a tag with a thickness of 0.9 mm or less and can be bent. Furthermore, it is also desired that such battery is a secondary battery reusable through charging and the charging is completed in a short period of time. Additionally, there exists a desire for an RFID tag in which such rechargeable battery can be replaced with a new battery according to the period of utilization time thereof.

It is therefore an object of the present invention to provide an RFID tag with a thickness of 0.9 mm or less and which includes therein a bendable power source reusable by charging.

### Means for Solving the Problem

An RFID tag of the present invention is an RFID tag including an IC module, an antenna, and a power source or including an IC module, an antenna, a display element, and a power source characterized by including an organic radical battery as the power source. Even if the RFID tag has a thickness of 0.9 mm or less, the organic radical battery can be installed therein.

The organic radical battery employed in the present invention is a battery using an oxidation-reduction reaction of an organic radical compound as an active material. Patent Document 3 discloses an organic radical battery in which a nitroxide radical compound, an aryl-oxy radical compound, or a polymer compound with particular amino-triazine structure is used as a material of a positive electrode. Also, Patent Document 5 discloses a radical battery wherein an electrode reaction on at least one of a positive electrode and a negative electrode is a reaction in which a radical compound with a thiazyl radical is obtained as a reaction product or a produced material.

By adopting such organic radical battery, it is possible to provide a thin-film, lightweight, foldable, and rechargeable IC-card power source. The organic radical battery can be charged in a short period of time and is most suitable as a power source for a device of an IC card size.

In the present invention, the layout of the power source and the IC module in the RFID tag can be considered in various ways. There can be considered a case wherein there is disposed a substrate including a cavity section and at least the power source is stored in the cavity section and a case wherein there is disposed a substrate including a concave section, at least the power source is stored in the concave section, and there is further disposed a seal layer to cover the power source arranged in the concave section. Moreover, there can also be considered a case wherein an IC module is disposed on a substrate and the power source is arranged in a seal layer covering the substrate. By disposing in a substrate a cavity section to store the power source and a concave section in which the power source is allocated as above, flatness of the RFID tag can be secured.

Additionally, waterproofness can be increased by disposing a layer of silicon oxide (SiOx; x=1 to 2) and a layer of silicon nitroxide (SiOxN; x=0.5 to 1.5) on a substrate surface on which the power source is disposed and on a seal layer surface opposing the power source. This is because higher waterproofness is desired for the organic radical battery in consideration of the environment of utilization thereof. Waterproofness can be increased also by sealing the power source in the seal layer. Furthermore, the antenna may be arranged on the substrate on which the power source and the IC module exist, and it is also possible that a seal-type antenna is employed and the antenna also serves as the seal layer. Or, the antenna may serve as the substrate.

Also, when the seal layer existing at a location opposing at least the power source is made peelable, the battery can be easily replaced.

In addition, a display element may be arranged in the RFID tag of the present invention. The display element may include a thin-film liquid-crystal display element, an ElectroLuminescent (EL) element, electronic paper, and an Light Emitting Diode (LED) display element. This makes it possible to display useful information such as a balance on the RFID tag.

Moreover, a temperature sensor may be disposed in the RFID tag of the present invention. It is hence possible that the tag is fixed on food, a drink, a fresh flower, a blood product, a medicine, a precision instrument, and the like and a temperature thereof is transmitted to an external device for the monitoring thereof.

Also, a sensor to detect biometric information such as a pulse rate, a blood pressure, information of an electrocardiogram, information of an electromyogram, and the like may be arranged in the RFID tag of the present invention. Hence, by fixing the sensor on a human body, it is possible to attain the biometric information and to send the information to other persons.

Also, a positional information sensor may be disposed in the RFID tag of the present invention. Therefore, the tag may be used to obtain positional information of objects and persons.

In addition, notifying means may be installed in the RFID tag of the present invention. The notifying means may include means for notifying by use of light, sound, vibration, smell, and the like. As a result, it is possible to indicate a communication operation by use of light, sound, or vibration and to notify a communication state and a communication result.

Incidentally, not only one of the display element, the temperature sensor, the biometric information sensor, the positional information sensor, and the notifying means, but also an arbitrary combination of two or more thereof may be arranged in the RFID tag of the present invention.

### ADVANTAGE OF THE INVENTION

In accordance with the present invention, there is provided an RFID tag which is thin, lightweight, and suitable to be carried about, which is foldable, and which includes a power source.

### BEST MODE FOR CARRYING OUT THE INVENTION

Next, description will be given of a favorable embodiment of the present invention by referring to drawings.

### [1] RFID Tag (Contactless IC Card)

First, description will be given of an RFID tag in accordance with the present invention. Incidentally, in the following description, the same or equivalent components are assigned with the same reference numerals and duplicated description will be avoided. Also, the dimensional ratio in the drawings does not necessarily match that of the description.

FIG. 1 shows an example of structure of an RFID tag. The RFID tag shown has structure in which an overlay 9a, a core sheet 8a, a core sheet 8b, and an overlay 9b are laminated in this order. The core sheets 8a and 8b serve as substrates.

FIG. 2(a) is a view of the overlay 9b viewed from above and FIG. 2(b) is a cross section X-Y of FIG. 2(a). The overlay 9b is an about 0.1 mm thick, transparent, plastic film made of a resin of PVC, ABS, PET-G, or the like. In the overlay 9b, holes 11a are disposed in locations overlapped with charge terminals 7 (FIG. 3(a)) of the core sheet 8a.

FIG. 3(a) is a view of the core sheet 8b viewed from above and FIG. 3(b) is a cross section X-Y of FIG. 3(a). The core sheet 8b is a plastic sheet with a thickness from 0.25 mm to 0.35 mm made of a resin of PVC, ABS, PET-G, or the like. In the core sheet 8b, a through-hole 6 are arranged for charge wiring and charge terminals 7, and the core sheet 8b includes a cavity section 10 (concave section) to accommodate an organic radical battery 1.

FIG. 4(a) is a view of the core sheet 8a viewed from above and FIG. 4(b) is a cross section X-Y of FIG. 4(a). The core sheet 8a is a plastic sheet with a thickness from 0.25 mm to 0.35 mm made of a resin of PVC, ABS, PET-G, or the like; on the core sheet 8a, an organic radical battery 1, an IC module 2, an antenna 3, a lead 4, and charge wiring 5 are disposed. The organic radical battery 1 is disposed here as a power source to drive the IC module 2. The antenna 3 is a flat coil antenna to be connected to the IC module 2.

FIG. 5(a) is a view of the overlay 9a viewed from above and FIG. 5(b) is a cross section X-Y of FIG. 5(a). The overlay 9a is an about 0.1 mm thick, transparent, plastic film made of a resin of PVC, ABS, PET-G, or the like.

The overlay 9a, the core sheets 8a and 8b, and the overlay 9b are laminated in this order to be thermally crimped (temperature of 100° C. to 150° C., pressure of 1 kg/cm² to 10 kg/cm², crimping time of 30 sec to 10 min) and the lamination is then fused to each other to thereby attain the RFID tag of the exemplary embodiment shown in FIG. 1.

In the RFID tag described above, although the power source (the organic radical battery 1) is arranged on the core sheet 8a to be housed in the cavity section 10 formed in the core sheet 8b, the configuration of the power source of the present invention is not restricted by this configuration. For example, the power source may be arranged in the seal layer covering the substrate. FIG. 6(a) is a cross-sectional view of a seal layer 100 in which the organic radical battery 1 is installed and FIG. 6(b) is a view of the seal layer 100 viewed from below. An outer circumferential section 102 on a rear surface of the seal layer 100 is adhesive. Also, the organic radical battery 1 is housed in a battery cover 101, and tabs 11b made of metal or carbon extends from the battery 1. The tabs 11b are used to electrically connect to the respective electrodes of the battery 1.

FIG. 7(a) is a plan view of the RFID tag in which the organic radical battery 1 is in the seal layer 100, and FIG. 7(b) is a cross-sectional view taken along line X-Y of FIG. 7(a). The RFID tag has structure in which an overlay 9a, a core sheet 8a, a core sheet 8b, an overlay 9b, and a seal layer 100 including the organic radical battery 1 are laminated in this sequence. By use of the adhesive section 102 in the outer circumferential section of the rear surface of the seal layer 100, the seal layer 100 can be fixed onto the core sheet 8b. When the seal layer 100 is fixed, the tabs 11b of the battery 1 overlap with the terminals 12 of the IC module 2. As a result, the battery 1 electrically connects to the IC module 2. Furthermore, the overlay 9b and the core sheet 8b are provided with opening sections in which the tabs 11b and the battery 1 are placed when the seal layer 100 is fixed.

Incidentally, to increase waterproofness, on the surfaces of the seal layer 100 and the battery cover 101 opposing the opening sections in which the battery 1 is installed and the battery 1, a layer of silicon oxide (SiOx; x=1 to 2) with a thickness of about 30 nm to 200 nm may be formed, for example, by evaporation.

FIG. 8(a) is a plan view of an RFID tag including a seal layer covering part of the substrate (core sheet) and the organic radical battery 1, and FIG. 8(b) is a cross-sectional view taken along line X-Y of FIG. 8(a). In the core sheet 8b, there is formed a spatial section between the upper and lower surfaces thereof, and the organic radical battery 1 disposed on the core sheet 8a is housed in the spatial section of the core sheet 8b. Moreover, the seal layer 100 is arranged on the overlay 9b to cover the organic radical battery 1 and to close the spatial section. Here, the seal layer 100 is peelable; by peeling off the seal layer 100, the organic radical battery 1 therein can be easily replaced. Also, although a flexible plastic material is employed for the core sheet 8a and 8b and the overlays 9a and 9b to facilitate bending of the battery, it is favorable that a flexible resin material or a piece of metallic foil is similarly adopted for the seal layer 100.

FIG. 9(a) is a plan view of an RFID tag with a display element, the tag including a seal layer covering part of the substrate (core sheet) and the organic radical battery 1. FIG. 9(b) is a cross-sectional view taken along line X-Y of FIG. 9(a), and FIG. 9(c) is a cross-sectional view taken along line W-Z of FIG. 9(a). In the core sheet 8b, there is formed a spatial section to accommodate the organic radical battery 1, and the organic radical battery 1 disposed on the core sheet 8a is housed in the spatial section of the core sheet 8b. Also, a spatial section is formed in the core sheets 8a and 8b to accommodate a display element 102, and the display element 102 disposed on the overlay 9b is housed in the spatial section of the core sheets 8a and 8b. In addition, the seal layer 100 is arranged on the overlay 9b to cover the organic radical battery 1 and to close the spatial section. Here, the seal layer 100 is peelable; by peeling off the seal layer 100, the organic radical battery 1 therein can be easily replaced.

Furthermore, the display element 102 of the example may be adopted for an RFID tag in which the organic radical battery 1 is disposed in the cavity section 10 between the core sheets 8a and 8b as in the example shown in FIG. 1.

The display element 102 is connected by display element wiring 104 to the organic radical battery 1, the IC module 2, and a switch 103. By an operation of the switch 103 exposed to the overlay 9b, the display element 102 can display information in the IC module 2. For example, in a situation wherein the RFID tag is adopted as a prepaid-type contactless IC card (electronic money IC card), a balance can be displayed on the display element 102 by pressing the switch 103.

The display element may be a liquid-crystal display element, an EL display element, and electronic paper. An example of the liquid-crystal display element includes an opposing electrode 301, a liquid-crystal layer 302, a driving electrode 303, and a backlight 304 as shown in FIG. 10a. Additionally, an example of the EL display element includes a glass substrate 305, an anode (transparent electrode) 306, an EL film 307, and a cathode 308 as shown in FIG. 10b. Also, an example of electronic paper includes a transparent resin substrate 309, a transparent electrode 310, a microcapsule layer 311, and a driving electrode (TFT electrode) 312 as shown in FIG. 10c.

In this regard, to increase waterproofness, on the surfaces of the seal layer 100 opposing the concave section (spatial section) in which the battery is installed and the battery 1, a layer of silicon (SiOx; x=1 to 2) with a thickness of about 30 nm to 200 nm or a layer of silicon nitroxide (SiOxN; x=0.5 to 1.5) with a thickness of about 30 nm to 200 nm may be formed, for example, by evaporation.

FIG. 11(a) is a plan view of an RFID tag with an arbitrary sensor and a notifying element, FIG. 11(b) is a cross-sectional view taken along line X-Y of FIG. 11(a), and FIG. 11(c) is a cross-sectional view taken along line W-Z of FIG. 11(a). In the core sheet 8b, a cavity section 10 (concave section) is formed to accommodate the organic radical battery 1, and the organic radical battery 1 disposed on the core sheet 8a is housed in the cavity section 10 of the core sheet 8b. Also, on the core sheet 8a, a sensor 14 and a notifying element 15 are disposed. The sensor 14 and the notifying element 15 are connected via wiring 13 to the organic radical battery 1 and the IC module 2. Moreover, although the sensor 14 is coated with the core sheet 8b, the notifying element 15 is exposed via the hole disposed in the overlay 9b.

Incidentally, although the organic radical battery 1 is fixed in the tag in the examples shown in FIGS. 11(a) to 11(c), the battery 1 can be replaced by peeling off the seal layer 100 as shown in the configuration of FIGS. 7(a) to 9(b). In this case, to increase waterproofness, it is favorable to dispose a layer of silicon (SiOx; x=1 to 2) or a layer of silicon nitroxide (SiOxN; x=0.5 to 1.5) with a thickness of about 30 nm to about 200 nm on a surface of the seal layer 100 opposing the concave section (spatial section) in which the battery is disposed and the battery. In addition, it is also possible to add the display element 102 to the RFID tag of this example as shown in FIG. 9(a).

An example of the sensor 14 may be a temperature sensor, a biometric information sensor to detect biometric information such as a pulse rate, a blood pressure, information of an electrocardiogram, information of an electromyogram, or the like.

An example of the notifying element 15 may be an element to produce light, sound, vibration, or smell. As the light emitting element, an LED or an EL element is available. The sound generating element may be an ultra thin-film speaker in the shape of paper. As the vibrating element, a piezoelectric element or a magnetostrictor element is available.

As the element to produce smell using electricity, there can be considered an element wherein a perfume which is odorless at a room temperature and which vaporizes when the environmental temperature rises to produce smell is combined with an electrothermal converter such as a heater. Or, there may be employed an element which applies pressure onto a microcapsule containing a perfume therein to tear the microcapsule to disperse smell.

In a case wherein the temperature sensor exemplified above is arranged as the sensor 14 of the RFID tag of the present invention, if the tag is fixed on food, a drink, a fresh flower, a blood product, a medicine, a precision instrument, and the like, it is possible to monitor the temperature thereof. For example, a history of temperature thereof during transport and storage can be monitored in a real time fashion; if an abnormality occurs, the temperature history can be used to facilitate a follow-up survey. Additionally, the sensor may also be employed as a body temperature sensor to be fixed onto a human body for use thereof. For example, in a hospital, a change in the body temperature of a patient can be attained in the real time manner in the nurse center.

Additionally, if the display element 102 is mounted on the RFID tag together with the temperature sensor, it is possible, in addition to transmission of the detected current temperature or the temperature history, to display it on the display element 102.

Also, if a biometric information sensor is arranged as the sensor 14 in the RFID tag, it is possible to attain information of a state of activities or a state of health of an elderly person or an unhealthy person living alone who wears the RFID tag, and the information can be transmitted to a doctor and his or her family members.

In addition, when the display element 120 is installed in the RFID tag together with the biometric information sensor, it is possible to transmit the blood pressure, the pulse rate, and the like thus detected to an external device and the bearer can know these items by use of the display element 120. If a temperature sensor is additionally installed in the tag, it is possible to send and to display the body temperature.

Moreover, if a positional information sensor is arranged as the sensor 14 in the RFID tag and the tag is fixed on an object or a person, it is possible to externally attain positional information of the object or the person. For example, it is possible to find out a lost child in an amusement part, to detect a delivered item, or to attain information of a state of activities of an elderly person or an unhealthy person living alone.

Furthermore, if the positional information sensor and one or more of the display device 120, the temperature sensor, and the biometric information sensor are mounted on the RFID tag, it is for example possible to obtain through the external transmission, together with positional information of the elderly person or the unhealthy person living alone, biometric information and temperature information; and the bearer can also recognize the biometric information and the temperature information using the display element 120.

Additionally, if a notifying element is installed in the RFID tag, it is possible to produce light, sound, or vibration at RF communication using the antenna 3 or at detection by the sensor 14. Also, in a situation wherein the RFID tag including the notifying element 15 is used as a contactless IC card with an electronic money function, when a bearer passes a ticket gate, the card itself can notify success of RF communication by light, sound, or vibration. In this situation, the balance of electronic money may be notified to a blind person by use of sound. Furthermore, in a case wherein the RFID tag including the notifying element 15 is stored in a wallet or a pass holder or is fixed onto a wallet or a bunch or keys, if the pertinent object is lost, it is possible to make the tag produce sound or light to thereby facilitate detection thereof.

Moreover, if the notifying element 15 and one or more of the display device 120, the temperature sensor, the biometric information sensor, and the positional information sensor are mounted on the RFID tag, it is also possible, in addition to the function described above, to notify the elderly person or the unhealthy person living alone of abnormality in the biometric information and the temperature information using sound or the like to urge bed rest.

As above, description has been given of a favorable embodiment of the present invention; however, in the RFID tag in accordance with the present invention, the antenna 3 may also be arranged on the same substrate (core sheet 8a) as for the organic radical battery 1 or may also be disposed on the seal layer 100 to serve as the seal layer 100.

FIG. 12 shows a conceptual diagram of an example of the IC module adopted in the RFID tag of the present invention. The IC module 2 includes a memory 2a (ROM, RAM), a control microprocessor 2b, a command 2d, a clock 2e, and a front end 2f. Here, power from the organic radical battery 1 is employed through the IC module 2 to emit a radio wave and to rewrite and to record data.

### [2] Thin-Film Organic Radical Battery

Next, description will be given of a thin-film organic radical battery adopted in the RFID tag of the present embodiment. FIG. 13 is a perspective view of a thin-film organic radical battery and FIG. 14 is a perspective disassembly diagram showing an internal configuration of the battery.

The thin-film organic radical battery is an organic radical battery of thin-film type with a thickness of 0.7 mm or less. In a basic configuration of the thin-film organic battery, a radical positive electrode 202 including a stable radical compound as a material thereof, a separator 203 including porous polypropylene and cellulose, and a negative electrode 204 including metallic lithium or the like which are laminated in this order. In this lamination, the separator 203 penetrated with electrolyte solution is sandwiched by exterior films 201 on both sides thereof and is sealed therebetween. In addition, the positive electrode 202 and the negative electrode 204 are connected respectively to a positive electrode lead 205 and a negative electrode lead 206 so that power is attained through these leads in the configuration. As exterior films 201, there is employed, for example, an aluminum laminate film with low permeability of water vapor.

Next, description will be given of respective constituent components of an organic radical battery adopted in the present invention.

### (1) Radical Positive Electrode

As the positive electrode active substance for the radical positive electrode 202, there can be adopted nitroxide radical polymer including in its molecule as partial structure, nitroxide radical represented by the following formula (1) in the reduced state and oxoammonium (nitroxide cation) represented by the following formula (2) in the oxidation state.

If an organic radical battery is employed as a primary battery, it is considered that at discharge thereof, electric charge is transferred between the nitroxide radical group represented by the following formula (1) and oxoammonium group represented by the following formula (2). Additionally, if the battery is employed as a secondary battery, it is considered that at charge and discharge thereof, electric charge is reversibly transferred between the nitroxide radical group represented by the following formula (1) and oxoammonium group represented by the following formula (2). Here, the nitroxide radical group indicates a substituent in which oxygen atoms comprising nitroxide radical including a combination of oxygen atoms and nitrogen atoms include unpaired electrons. In the nitroxide radical group, unpaired electrons on oxygen are stabilized due to an electron attracting property of nitrogen atoms.

By using such nitroxide radical polymer, a battery with high energy density can be stably operated.

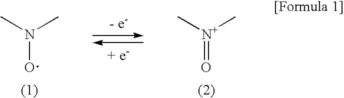

The following formulas (3) to (7) show representative structural examples of nitroxide radical polymer.

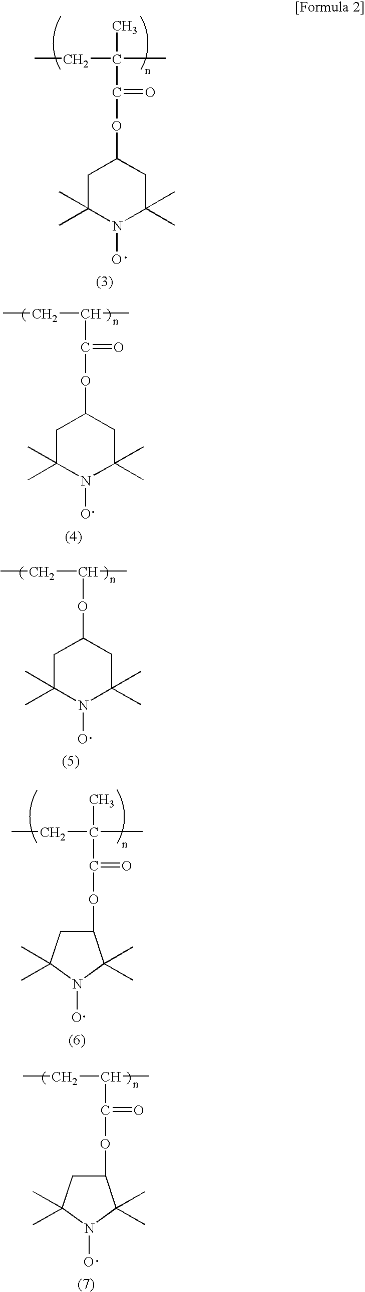

In the radical polymers represented by these formulas (3) to (7), the positive electrode substance is nitroxide radical represented by the formulas (3) to (7) in the reduced state and is oxoammonium (nitroxide cation) represented respectively by the following formulas (8) to (12) in the oxidation state. It is considered that when the battery is operating, electric charge is transferred between the nitroxide radical of the formulas (3) to (7) and the oxoammonium (nitroxide cation) of the following formulas (8) to (12).

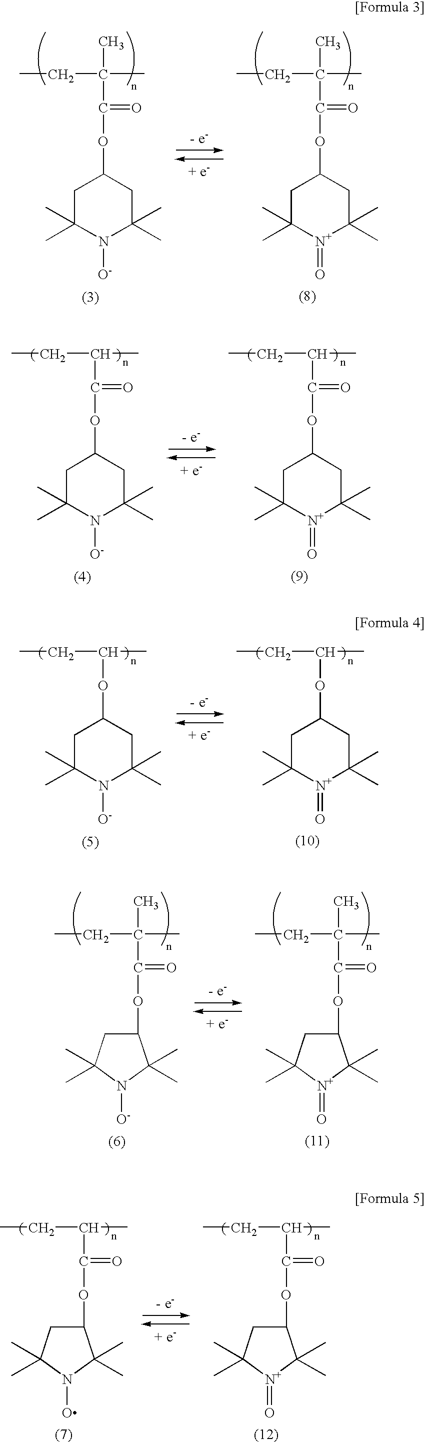

Incidentally, these nitroxide radical polymers favorably have a weight-average molecular weight of 500 or more, and further desirably 5000 or more. This is because the polymers are not easily dissolved in the battery electrolyte solution if the weight-average molecular weight is 500 or more and are almost insoluble if the weight-average molecular weight is 5000 or more. The polymers in the form of polymer may be in the shape of a chain, a branch, or a network. Also, there may be employed structure including a bridge constructed by a crosslinking agent.

In addition, although each of these nitroxide radical polymers may be used as a single element, it is also possible to combine two or more kinds thereof with each other. Furthermore, it is also possible to combine these elements with another active material.

Additionally, when forming an electrode using nitroxide radical polymer, a conductivity giving agent may also be mixed in order to lower impedance. The materials of the conductivity giving agent may include fine particles of carbon such as graphite, carbon black, and acetylene black and conductive polymers such as polyaniline, polypyrrole, polythiophene, polyacetylene, and polyacene.

Also, to increase binding between the nitroxide radical polymer and the conductivity giving agent, there may be used a binding agent. Such binding agents may include resin binder such as polytetrafluoroethylene, poly vinylidene fluoride, vinylidene fluoride-hexafluoropropylene copolymer, vinylidene fluoride-tetrafluoropropylene copolymer, styrene.butadiene copolymer lubber, polypropylene, polyethylene, polyimid, and various kinds of polyuretane.

The radical positive electrode 202 is constructed by forming nitroxide radical polymer as the radical positive electrode material on a positive electrode collector, and as the positive electrode collector, there may be adopted foil or a flat plate made of nickel, aluminum, copper, gold, silver, an aluminum alloy, stainless steel, carbon, or the like. Particularly, to facilitate folding of the battery, it is favorable to construct a positive electrode in which nitroxide radical polymer in the state of gel is formed on foil of a collector material.

### (2) Negative Electrode

As an active material for the negative electrode 204, lithium metal and lithium alloys are available. The lithium alloys may include a LiAl alloy, a LiAg alloy, a LiPb alloy, a LiSi alloy, a Li—Bi—Pb—Sn—Cd alloy, and a Li—Ga—In alloy. The contour thereof is not particularly restricted and may be, for example, a contour of a thin film, a contour constructed by solidified powder, and a contour of fiber or flakes. Also, these negative electrode active materials may be used as a single material or in combination.

The negative electrode 204 is constructed by forming the active material described above on a collector, and as the collector, there may be used the same material of the collector including the positive electrode. Naturally, for the active material and the collector, the material and thickness are selected to facilitate bending of the battery.

Also, to increase binding between the constituent materials of the negative electrode 204, there may be used a binding agent. Such binding agents may be polytetrafluoroethylene, poly vinylidene fluoride, vinylidene fluoride-hexafluoropropylene copolymer, vinylidene fluoride-tetrafluoropropylene copolymer, styrene.butadiene copolymer lubber, polypropylene, polyethylene, polyimid, partially carboxylated cellulose, and various kinds of polyuretane.

### (3) Separator

To prevent contact between the radical positive electrode 202 and the negative electrode 204, there may be adopted a separator 203 including a porous film of polyethylene, polypropyrene, or the like; a cellulose film, and a nonwoven fabric.

### (4) Electrolyte

The battery 1 shown in FIG. 13 includes a separator 203 penetrated with electrolyte solution.

The electrolyte solution of the separator 203 is employed to transport charge carriers between the electrodes, i.e., the negative electrode 204 and positive electrode 202, and it is generally favorable that the electrolyte solution has an ion conductivity of about 10⁻⁵ to 10⁻¹ S/cm at 20° C. As the electrolyte solution, it is possible to employ, for example, electrolyte solution produced by dissolving electrolyte salt in solvent.

As the electrolyte salt, there may be used, for example, LiPF₆, LiClO₃, LiBF₄, LiCF₃SO₃, LiN(CF₃SO₂)₂, LiN(C₂F₅SO₂)₂, LiC(CF₃SO₂)₃, and LiC(C₂F₅SO₂)₃.

As the solvent to dissolve such electrolyte salt, there may be adopted organic solvents, for example, ethylene carbonate, propylene carbonate, dimethylcarbonate, diethylcarbonate, methylethylcarbonate, γ-butyl lactone, tetrahydrofuran, dioxorane, sulforane, dimethylformamide, dimethylacetamide, N-methyl-2-pyrolidone. Each of these solvents may be used as a single solvent or two or more kinds thereof may be mixed in use.

Additionally, the battery may include a solid electrolyte in place of the separator 203. As the solid electrolyte, there may be used fluoride-vinylidene-based copolymers such as poly vinylidene fluoride, vinylidene fluoride-hexafluoropropylene copolymer, vinylidene fluoride-ethylene copolymer, vinylidene fluoride-monofluoroethylene copolymer, vinylidene fluoride-trifluoroethylene copolymer, vinylidene fluoride-tetrafluoroethylene copolymer, vinylidene fluoride-hexafluoropropylene-tetrafluoroethylene three-element copolymer; acrylnitrile-based copolymers such as acrylnitrile-methylmetacrylate copolymer, acrylnitrile-methylacrylate copolymer, acrylnitrile-ethylmetacrylate copolymer, acrylnitrile-ethylacrylate copolymer, acrylnitrile-metacrylic acid copolymer, acrylnitrile-acrylic acid copolymer, and acrylnitrile-vynil acetate copolymer; plyethylene oxide, ethylene oxide-propylene oxide copolymer, and polymers of acrylate and metacrylate. As the solid electrolytes, there may be used gel produced by penetrating electrolyte solution into such polymeric substance described above or the polymeric substance may be used in its original state. To facilitate folding of the battery, the electrolyte is desirably employed in the state of gel.

### (5) Battery Contour

The contour of the thin-film organic radical battery employed in the present invention is not limited to the sheet type shown in FIG. 13. In addition to the battery contour of the sheet type, there may be used a cylindrical contour, a rectangular contour, a coin-shaped contour, and the like. Such battery is produced by sealing a lamination or a roll of electrodes including a positive electrode, a negative electrode, an electrolyte, and a separator described above, by use of a metallic case, a resin case, metallic foil, a laminate film, and the like. However, from a viewpoint of easiness to reduce the thickness, the battery contour is desirably formed in a sheet type sealed by a laminate film. As the laminate film, there may be adopted a single item of a synthetic resin film, an item produced by fixing metallic foil such as aluminum foil onto a synthetic resin film, and an item produced by evaporating oxide such as SiO₂ onto a synthetic resin film.

### (Radical Polymer Synthesis Example)

A synthesis example of radical polymer represented by formula (5) described above is as follows.

First, monomer (2,2,6,6-tetramethylpiperidine-4-vyniloxy-1-oxyl) is synthesized. The monomer is synthesized, in the presence of iridium as a catalizer, through a heating reflux process for alcohol including associated radical and vynil acetate. Specifically, the monomer is synthesized according to zyanaru obu ji amerikan kemikaru sosaeti (Journal of The American Society, No. 124, pp. 1590-1591 (2002), Kokei Ishii et al) and Japanese Patent Laid-Open Publication Ser. No. 2003-73321.

Subsequently, the 2,2,6,6-tetramethylpiperidine-4-vyniloxy-1-oxy (monomer) is polymerized through a reaction represented by the following formula (13). A concrete method thereof will be described below.

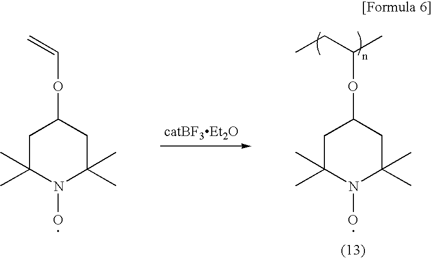

In an atmosphere of argon, 10.0 g (50.4 mmol) of 2,2,6,6-tetramethylpiperidine-4-vyniloxy-1-oxy (monomer) synthesized as above and 100 mL of dichloromethane are added in a 200 mL three-neck, round-bottom flask to be cooled down to −78° C. Further, 280 mg (2 mmol) of boron trifluoride-diethyl ether complex is added thereto and is homogenized, and then the treatment thereof is conducted at −78° C. for 20 hours. After the treatment is finished, the temperature is returned to the room temperature and the obtained solid matter is filtered and is rinsed by methanol several times and the obtained matter is dried in vacuum to attain a radical polymer represented by formula (5) as a red solid (yield 70%).

The IR spectrum of the obtained radical polymer is measured, the spectrum indicating a loss of the peak of 966,674 (cm⁻¹) due to the vynil radical which was measured in the case of the monomer described above. In addition, the attained radical polymer is insoluble in organic solvent and the like. The spin density of the radical polymer obtained through the ESR spectrum is 3.05×10²¹ spin/g. This substantially matches a spin density obtained on assumption that all radical radicals of the polymer are not deactivated through the polymerization and exist as radicals.

### (Production Example of Thin-Film Organic Radical Battery)

Next, description will be given of a production example of an thin-film organic radical battery.

1.68 g of fine powder of radical polymer represented by formula (5), 0.6 g of carbon powder (Ketchen black EC300j; manufactured by Raion), 96 mg of carboxymethyl cellulose (CMC:HB-9; manufactured by Nihon Zeon), 24 mg polytetrafluoroethylene (PTFE:F-104; manufactured by Daikin), and 7.2 mL water are stirred in a homogenizer to adjust to become a homogeneous slurry. The slurry is coated on aluminum foil (thickness of 20 μm: positive electrode collector) by an electrode producing coater and is then dried at 80° C. for three minutes to resultantly form a radical positive electrode layer with a thickness of 50 μm.

Next, the radical positive electrode thus attained is punched out to a 20 mm×20 mm square. A 3 cm long, 0.5 mm wide nickel lead is welded to the aluminum foil surface of the positive electrode. Additionally, lithium foil (thickness of 30 μm) is fixed onto copper foil (negative electrode collector) and is punched out to a 20 mm×20 mm square to resultantly form a negative electrode. A 3 cm long, 0.5 mm wide nickel lead is welded to the copper foil surface of the negative electrode.

Subsequently, the radical positive electrode, a separator (25 mm×25 mm square) of porous polypropylene, and the negative electrode are laminated in this order with the radical positive electrode slurry opposing the lithium layer to thereby produce an electrode pair with nickel leads.

Thereafter, two fusion-weldable aluminum laminate films (length 40 mm×width 40 mm×thickness 0.76 mm) are fusion welded on three sides thereof to form a contour of a bag, and then the electrode pair with nickel leads is placed therein. Moreover, 0.5 cc of electrolyte solution [mixed solution of ethylene carbonate (EC)/diethyl carbonate (DEC; mixing ratio EC:DEC=3:7) including electrolyte salt of 1.0 mol/L LiPF₆] is filled in the aluminum laminate case. In the process, one centimeter of each of the ends of the nickel leads of the electrode with nickel leads is placed outside of the aluminum laminate case, and then one unfused side of the case is fusion welded. As a result, the electrodes and the electrolyte solution are completely sealed in the aluminum laminate case.

In this way, a thin-film organic radical battery (length 40 mm×width 40 mm×thickness 0.4 mm) is produced. The battery is charged at 100 mA for 30 seconds and then is discharged at a fixed current of 0.1 mA. As a result, the battery discharge at an average voltage of 3.5 V for five hours (energy quantity of 1.8 mWh).

### EXAMPLES

### (RFID Tag Production Example 1)

Next, description will be given of a production example of an RFID tag according to the present embodiment.

An IC card as an RFID tag in a cross-sectional configuration shown in FIG. 1 is attained as follows.

First, there are prepared a 0.1 mm thick overlay 9b made of PVC, a 0.28 mm thick PVC core sheet 8b in which a though hole 6 for charge wiring and charge terminals 7 are arranged and which includes a cavity section 10 to store an organic radical battery 1; a 0.28 mm thick PVC core sheet 8a in which the organic radical battery 1, an IC module 2, an antenna 3, leads 4, and charge wiring 5 are disposed; and a 1.0 mm thick PVC overlay 9a. Thereafter, the overlay 9a, the core sheet 8a, the core sheet 8b, and the overlay 9a are laminated in this order from the bottom and are thermally crimped (120° C., pressure of 2 kg/cm², 2 min). As a result, an IC card shown in FIG. 1 is completely produced.

### (RFID Tag Production Example 2)

An IC card as an RFID tag shown in FIGS. 7(a) and 7(b) is obtained as follows.

There are prepared a 0.1 mm thick PVC overlay 9b including an opening section through which the organic radical battery 1 and the tabs 11b are passable, a 0.28 mm thick PVC core sheet 8b in which a though hole 6 for charge wiring and charge terminals 7 are arranged and which includes a spatial section to house the organic radical battery 1; a 0.28 mm thick PVC core sheet 8a in which the IC module 2, the antenna 3, the leads 4, and the charge wiring 5 are disposed; and a 1.0 mm thick PVC overlay 9a. Thereafter, the overlay 9a, the core sheet 8a, the core sheet 8b, and the overlay 9a are laminated in this order from the bottom and are thermally crimped (120° C., pressure of 2 kg/cm², 2 min) to be shaped into a card. A seal layer 100 including the thin-film organic radical battery 1 (length 40 mm×width 40 mm×thickness 0.4 mm) is fixed onto the card such that the battery 1 is housed through the opening section of the overlay 9b of the card in the spatial section of the core sheet 8b. As a result, an IC card shown in FIGS. 7(a) and 7(b) is completely produced.

### (RFID Tag Production Example 3)

An IC card as an RFID tag shown in FIGS. 9(a), 9(b), and 9(c) is attained as follows.

There are prepared a 0.1 mm thick PVC overlay 9b including an opening section through which the organic radical battery 1 and the tabs 11b are passable, a 0.28 mm thick PVC core sheet 8b in which a though hole 6 for charge wiring and charge terminals 7 are arranged and which includes a spatial section to house the organic radical battery 1 and a display element 102; a 0.28 mm thick PVC core sheet 8a in which the IC module 2, the antenna 3, the leads 4, the charge wiring 5, and the display element 102 are disposed; and a 1.0 mm thick PVC overlay 9a. Thereafter, the overlay 9a, the core sheet 8a, the core sheet 8b, and the overlay 9b are laminated in this order from the bottom and are thermally crimped (120° C., pressure of 2 kg/cm², 2 min) to be shaped into a card. A seal layer 100 including the thin-film organic radical battery 1 (length 40 mm×width 40 mm×thickness 0.4 mm) is fixed onto the card such that the thin-film organic radical battery 1 is housed through the opening section of the overlay 9b of the card in the spatial section of the core sheet 8b.

As a result, an IC card shown in FIGS. 9(a), 9(b), and 9(c) is completely produced.

### BRIEF DESCRIPTION OF DRAWINGS

FIG. 1 is a cross-sectional view showing an RFID tag in an exemplary embodiment of the present invention.

FIG. 2(a) is a plan view of the overlay 9b. (b) is a cross-sectional view taken along the line X-Y of (a).

FIG. 3(a) is a plan view of the core sheet 8b. (b) is a cross-sectional view taken along the line X-Y of (a).

FIG. 4(a) is a plan view of the core sheet 9a. (b) is a cross-sectional view taken along the line X-Y of (a).

FIG. 5(a) is a plan view of the overlay 9a. (b) is a cross-sectional view taken along the line X-Y of (a).

FIG. 6(a) is a cross-sectional view of a seal layer in which the thin-film organic radical battery is installed. (b) is a view of the seal layer shown in (a) viewed from below.

FIG. 7(a) is a plan view of the RFID tag employing a seal layer including therein the thin-film organic radical battery. (b) is a cross-sectional view taken along the line X-Y of (a).

FIG. 8(a) is a plan view of an RFID tag including a seal layer covering the substrate and the thin-film organic radical battery. (b) is a cross-sectional view taken along the line X-Y of (a).

FIG. 9(a) is a cross-sectional view of an RFID tag with a display element in an exemplary embodiment of the present invention. (b) is a cross-sectional view taken along the line X-Y of (a). (c) is a cross-sectional view along line W-Z of (a).

FIG. 10(a) is a diagram showing structure of a liquid-crystal display element. (b) is a diagram showing structure of an EL display element. (c) is a diagram showing structure of electronic paper.

FIG. 11(a) is a plan view of an RFID tag with an arbitrary sensor and a notifying element. (b) is a cross-sectional view taken along the line X-Y of (a). (c) is a cross-sectional view along line W-Z of (a).

FIG. 12 is a conceptual diagram of an example of an IC module adopted in an RFID tag of the present invention.

FIG. 13 is a perspective view of a thin-film organic radical battery.

FIG. 14 is a perspective disassembly diagram showing a configuration of a thin-film organic radical battery.

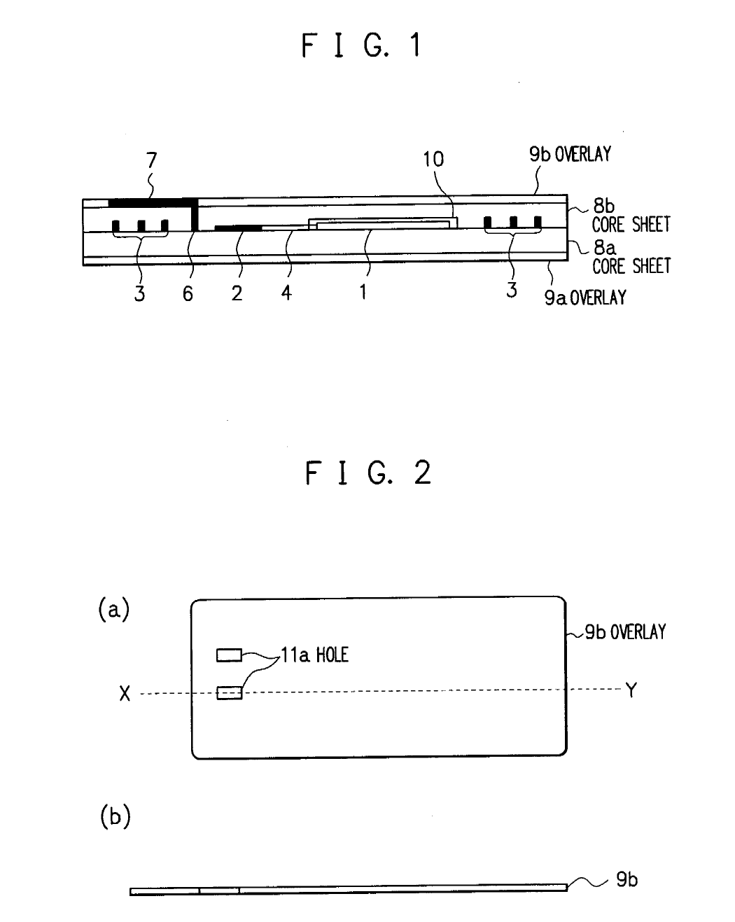

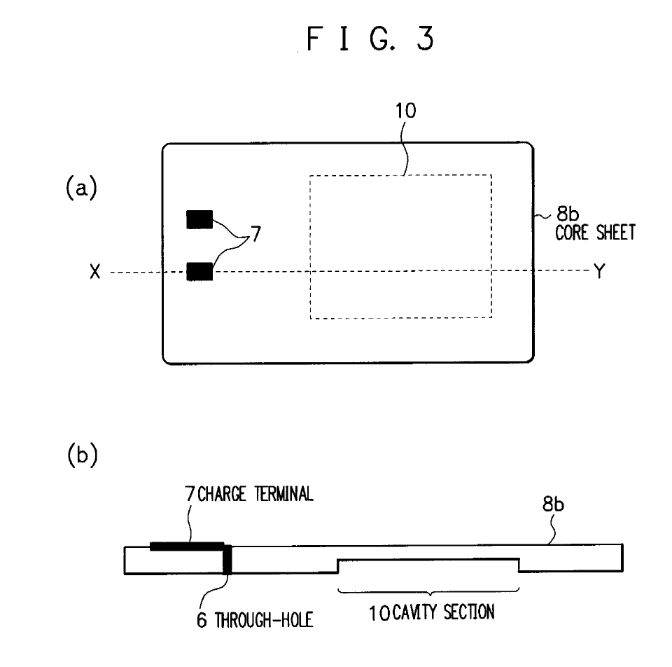

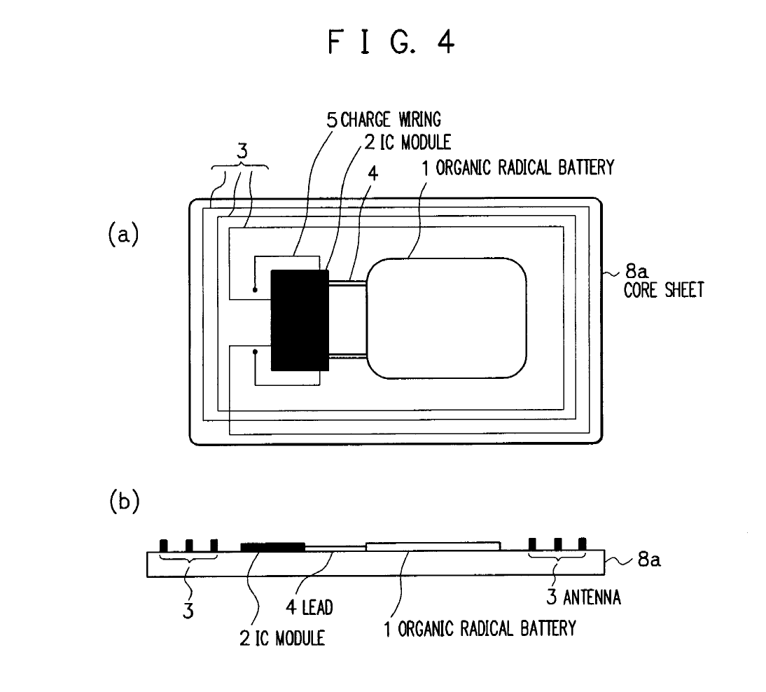

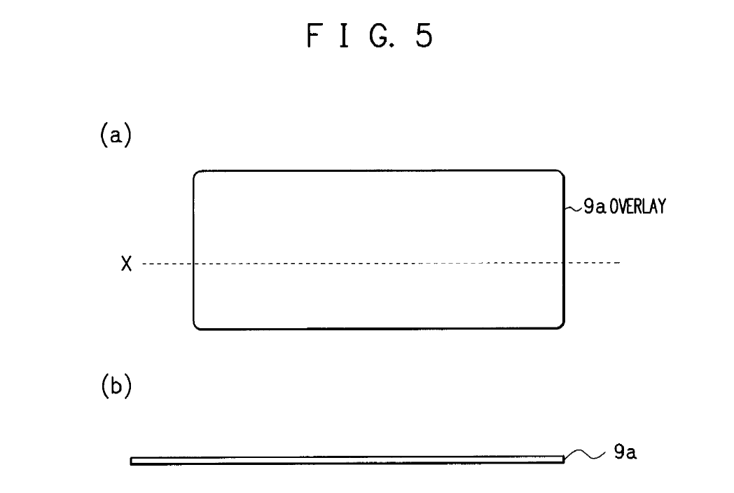

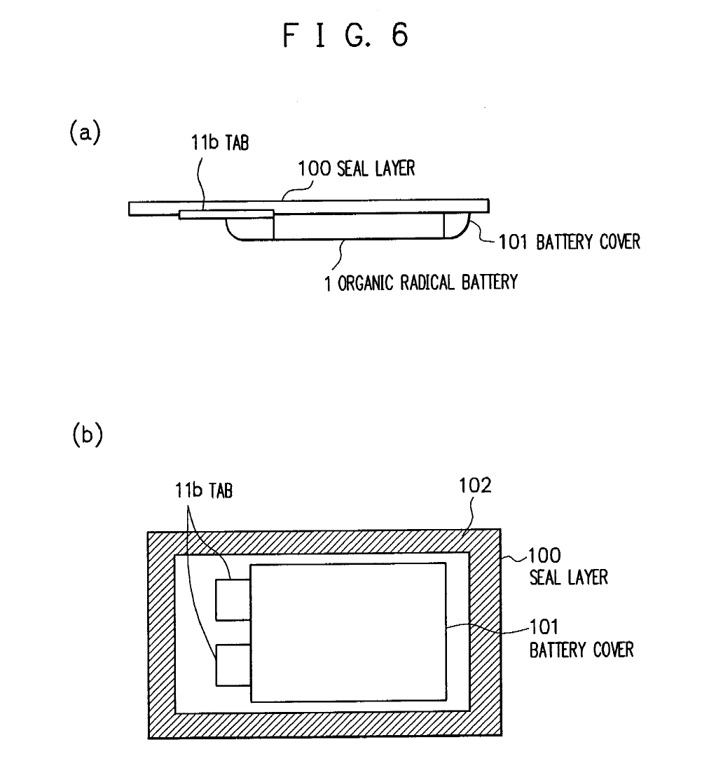

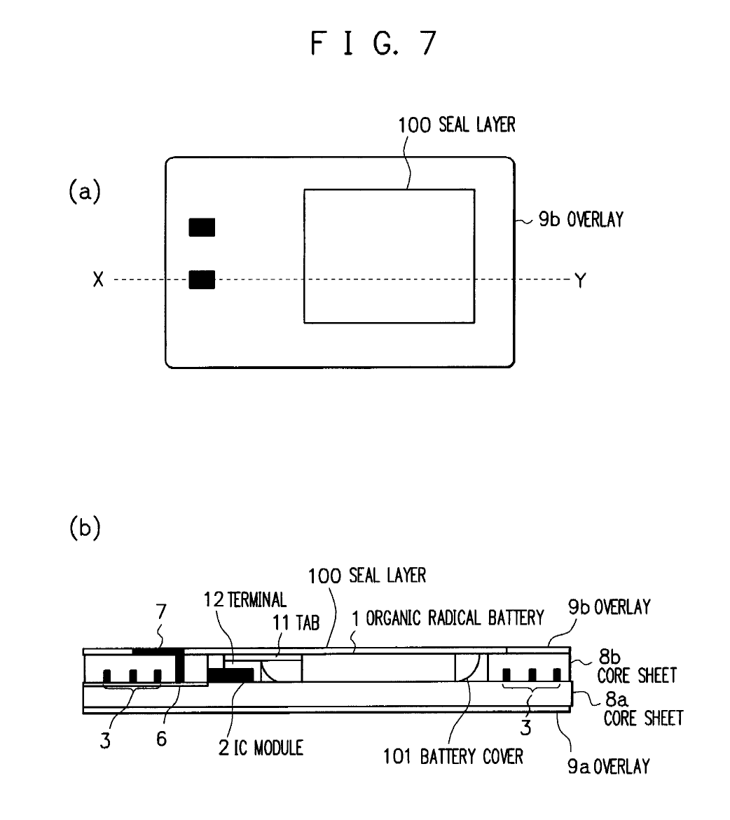

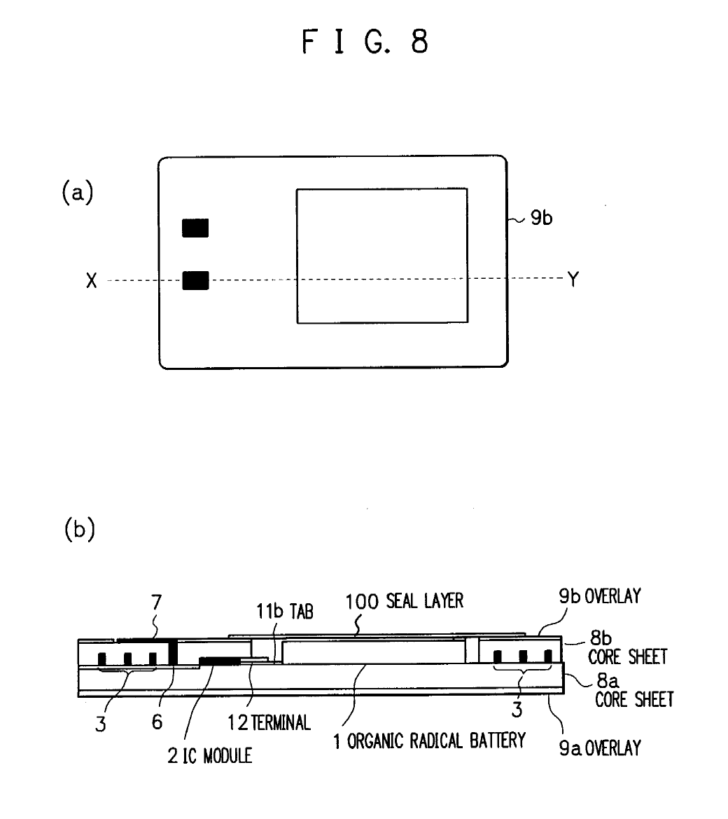

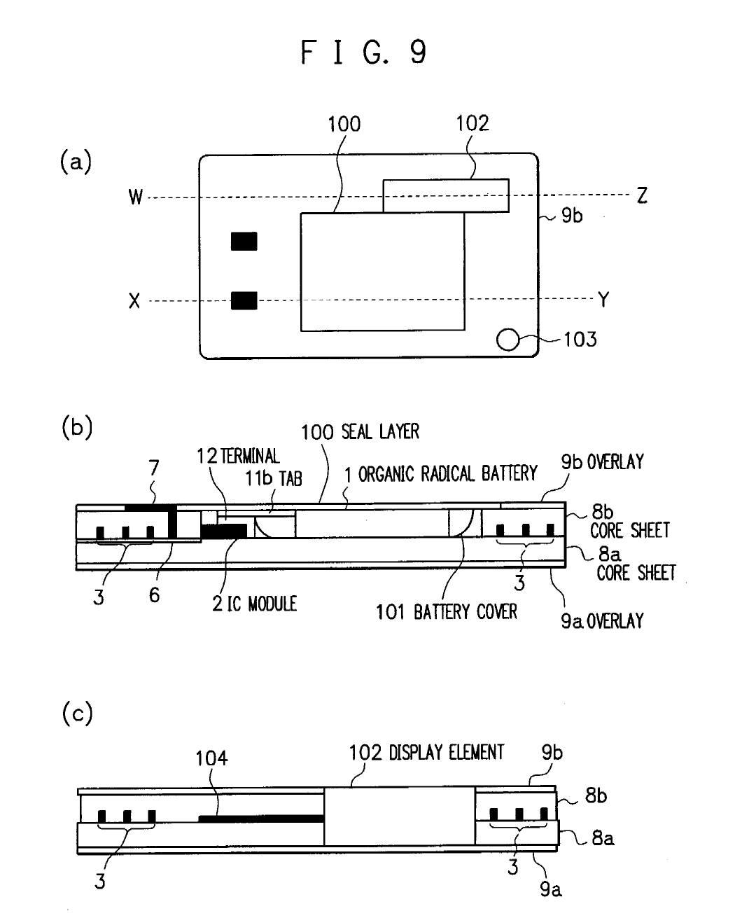

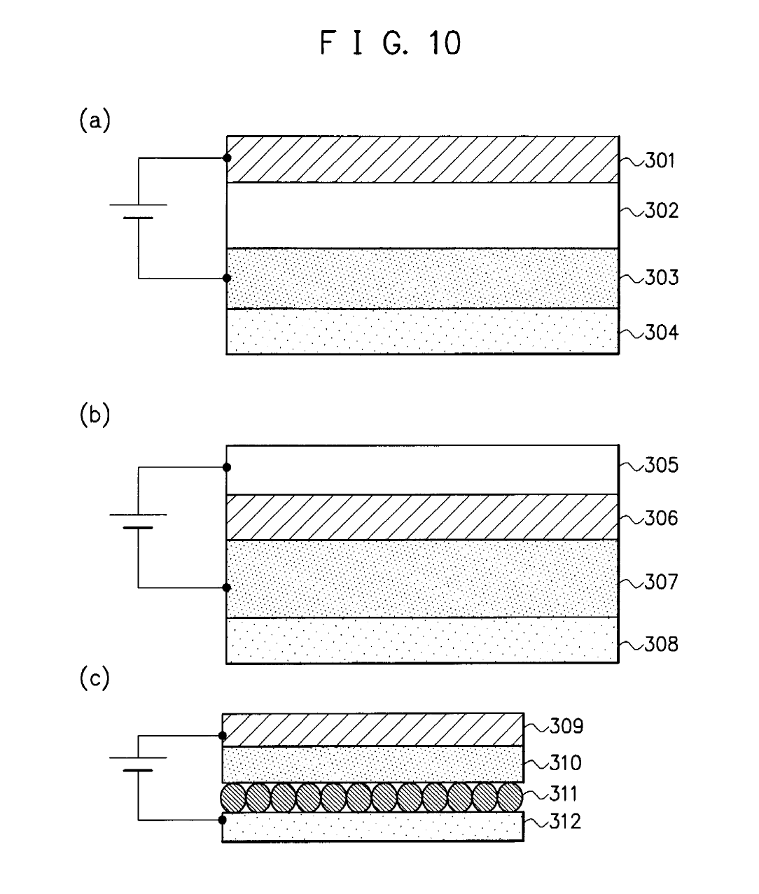

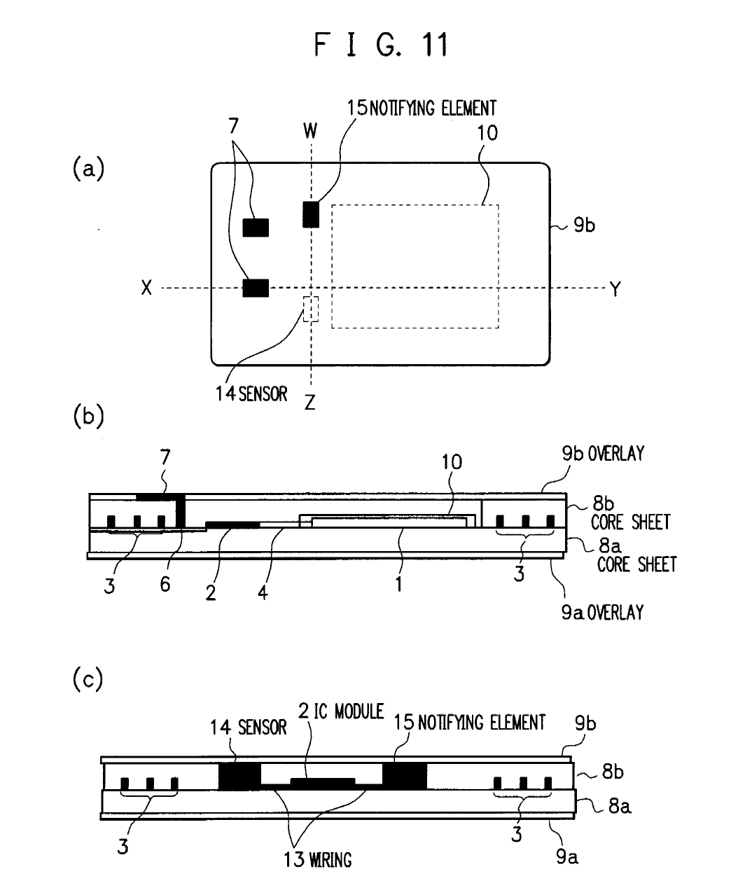

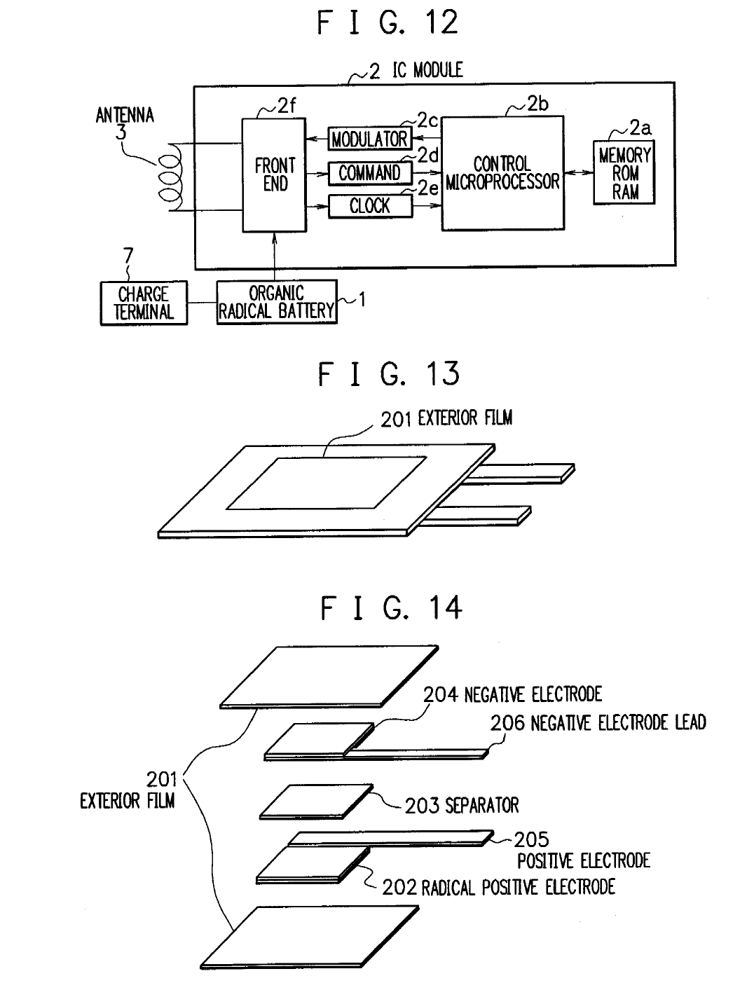

### DESCRIPTION OF REFERENCE NUMERALS

1 Thin-film organic radical battery
2 IC module
3 Antenna
4 Lead
5 Charge wiring
6 Through hole
7 Charge terminal
8a, 8b Core sheet
9a, 9b Overlay
10 Cavity section
11a hole
11b Tab
12 Terminal
13 Wiring
14 Sensor
15 Notifying element
100 Seal layer
101 Battery cover
102 Display element
103 Display element switch
104 Display element wiring
301 Opposing electrode
302 Liquid-crystal layer
303 Driving electrode
304 Backlight
305 Glass substrate
306 Anode (transparent electrode)
307 EL film
308 Transparent resin substrate
309 Transparent resin substrate
310 Transparent electrode
311 Microcapsule layer
312 Driving electrode (TFT electrode)
201 Exterior film
202 Radical positive electrode
203 Separator
204 Negative electrode
205 Positive electrode lead
206 Negative electrode lead

1. An RFID tag comprising an IC module, an antenna, and a power source, characterized in that an organic radical battery is installed therein as the power source.

2. The RFID tag in accordance with claim 1, wherein the RFID tag has a thickness of 0.9 mm or less.

3. The RFID tag in accordance with claim 1, further comprising a display element.

4. The RFID tag in accordance with claim 3, wherein the display element is either one of a liquid-crystal display, an organic EL display, and electronic paper.

5. The RFID tag in accordance claim 1, comprising a substrate, wherein the power source and the IC module are arranged in the substrate.

6. The RFID tag in accordance with claim 5, wherein the substrate comprises a cavity section, and at least the power source is stored in the cavity section.

7. The RFID tag in accordance with claim 5, wherein the substrate comprises a concave section and at least the power source is disposed in the concave section, the tag further comprising a seal layer to cover the power source disposed in the concave section.

8. The RFID tag in accordance with claim 1, comprising a substrate and a seal layer to cover the substrate, wherein the IC module is disposed on the substrate and the power source is disposed in the seal layer.

9. The RFID tag in accordance with claim 8, wherein the substrate includes a concave section at a position at which the power source is disposed.

10. The RFID tag in accordance with claim 7, wherein the antenna is disposed in the seal layer.

11. The RFID tag in accordance with claim 5, wherein the antenna is disposed on the substrate.

12. The RFID tag in accordance with claim 11, wherein the antenna is disposed on one and the same substrate together with the power source and the IC module.

13. The RFID tag in accordance with claim 7, wherein the substrate and the seal layer include materials respectively with flexibility.

14. The RFID tag in accordance with claim 7, wherein the seal layer is disposed to be peelable from the substrate.

15. The RFID tag in accordance with claim 7, wherein a silicon oxide layer (SiOx; x=1 to 2) is disposed on a surface of the substrate on which the power source is disposed and a surface of the seal layer opposing the power source.

16. The RFID tag in accordance with claim 7, wherein a silicon nitroxide layer (SiOxN; x=0.5 to 1.5) is disposed on a surface of the substrate on which the power source is disposed and a surface of the seal layer opposing the power source.

17. The RFID tag in accordance with claim 1, wherein the RFID tag is a contactless IC card.

18. The RFID tag in accordance with claim 1, including a temperature sensor.

19. The RFID tag in accordance with claim 1, including a biometric information sensor.

20. The RFID tag in accordance with claim 19, wherein the biometric information sensor is either one of a pulse rate sensor, a blood pressure sensor, an electrocardiogram sensor, and an electromyogram sensor.

21. The RFID tag in accordance with claim 1, including a positional information sensor.

22. The RFID tag in accordance with claim 1, including a notifying unit.

23. The RFID tag in accordance with claim 22, wherein the notifying unit produces either one of light, sound, vibration, and smell.
